(19) United States
(12) Patent Application Publication
(10) Pub. No.: US 2010/0158326 A1
(43) Pub. Date: Jun. 24, 2010

(54) SIGNATURE SYSTEM, SIGNATURE DEVICE, SIGNATURE VERIFICATION DEVICE, SIGNATURE VERIFICATION METHOD, COMPUTER READABLE MEDIUM AND COMPUTER DATA SIGNAL

(75) Inventor: Koji TAKEDA, Tokyo (JP)

Correspondence Address: SUGHRUE-265550, 2100 PENNSYLVANIA AVE. NW, WASHINGTON, DC, 20037-3213, US

(73) Assignee: FUJI XEROX CO., LTD, Tokyo (JP)

(21) Appl. No.: 12/474,565

(22) Filed: May 29, 2009

(30) Foreign Application Priority Data
Dec. 24, 2008 (JP) 2008-328000

(51) Int. Cl. G06K 9/00

(52) U.S. Cl. 382/119

(57) ABSTRACT

A signature verification device includes an acquisition unit, an electronic signature verification unit and a handwritten signature verification unit. The acquisition unit acquires an electronic document and handwriting information indicating handwriting of a handwritten signature which is put by a signer to a paper document corresponding to the electronic document, or an electronic signature value for a feature amount of the electronic document and the handwriting information. The electronic signature verification unit verifies whether or not the electronic signature value is a valid electronic signature value for a combination of the electronic document and the handwriting information. The handwritten signature verification unit verifies the handwriting information by comparing an image obtained by reading the paper document, which is associated with the electronic document and which the handwritten signature is put to by the signer, and the handwriting information.

### CROSS-REFERENCE TO RELATED APPLICATIONS

This application is based on and claims priority under 35 USC 119 from Japanese Patent Application No. 2008-328000 filed on Dec. 24, 2008.

### BACKGROUND

### Technical Field

The invention relates to a signature system, a signature device, a signature verification device, a computer readable medium storing a program and a computer data signal embedded with the program.

### SUMMARY

According to an aspect of the invention, a signature system includes a print unit, an acquisition unit, a signature value calculation unit, an association unit, an electronic signature verification unit and a handwritten signature verification unit. The print unit prints an electronic document to generate a paper document corresponding to the electronic document. The acquisition unit acquires handwriting information of a handwritten signature that is put to the paper document by a signer. The signature value calculation unit calculates an electronic signature value for (i) information which is generated from the electronic document and the handwriting information or (ii) information which is generated from a feature amount of the electronic document and the handwriting information, using a signature key of the signer. The association unit associates (i) the electronic signature value, (ii) the electronic document, (iii) the handwriting information, and (iv) the paper document to which the handwritten signature is put by the signer or an image obtained by reading the paper document to which the handwritten signature is put by the signer. The electronic signature verification unit verifies whether or not the electronic signature value associated with the electronic document is valid, using the electronic document, the handwriting information associated with the electronic document and a verification key of the signer. The handwritten signature verification unit verifies the handwriting information associated with the electronic document by comparing the handwriting information associated with the electronic document and the image, which is obtained by reading the paper document to which the handwritten signature is put by the signer and is associated with the electronic document.

### BRIEF DESCRIPTION OF THE DRAWINGS

Exemplary embodiments of the invention will be described below in detail based on the accompanying drawings, wherein:

FIG. 1 is a view for explaining the schematic configuration of a system according to an exemplary embodiment of the invention;

FIG. 2 is a view for explaining a concept of document management according to the exemplary embodiment;

FIG. 3 is a diagram showing one example of a part for putting a signature on a document in the system according to the exemplary embodiment;

FIG. 4 is a chart for explaining a processing flow for putting a signature on a document;

FIG. 5 is a diagram showing one example of a part for verifying the signature affixed to a document in the system according to the exemplary embodiment;

FIG. 6 is a flowchart showing one example of a signature verification process;

FIG. 7 is a diagram showing one example of the hardware configuration of a computer.

### DETAILED DESCRIPTION

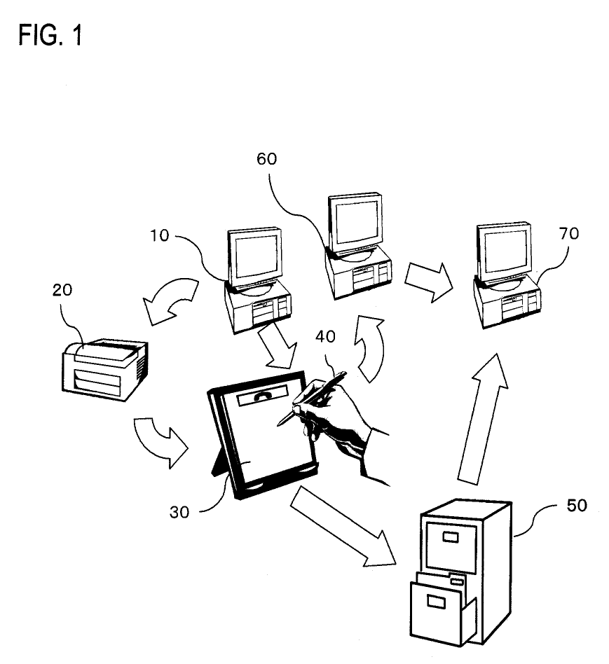

Firstly, referring to FIG. 1, the schematic configuration of a system according to an exemplary embodiment will be described below. This system provides a mechanism for signature and verification in which an electronic signature on an electronic document and a handwritten signature on a paper document that is obtained by printing out the electronic document are combined.

In this system, a printing device 20 prints an electronic document (document file) to be signed which is held in an electronic document processing device 10, and a user signs a paper document 30, which is the printing result, by hand using a signature device 40 having a pen therein. The user's handwritten signature, which is put on the paper document 30 in this manner, hereinafter will be referred to as a “handwritten signature.” The paper document 30 with the handwritten signature is stored in a reliable document cabinet (drawer 50), for example. Also, the signature device 40 has a function of detecting handwriting of the handwritten signature, that is, strokes that are paths of a pen point, and generates handwriting data representing the handwriting of the signature. Also, the signature device 40 stores a user's key for electronic signature (a signature key, for example a secret key in a public key cryptosystem) and has an electronic signature function. The signature device 40 acquires an electronic document to be signed from the electronic document processing device 10, and puts an electronic signature on data obtained by combining the electronic document and the handwriting data of handwritten signature. Then, information of the electronic signature generated by the signature device 40 is registered in a document management system 60 in association with the electronic document, a corresponding paper document with the handwritten signature, and the handwriting data of the handwritten signature.

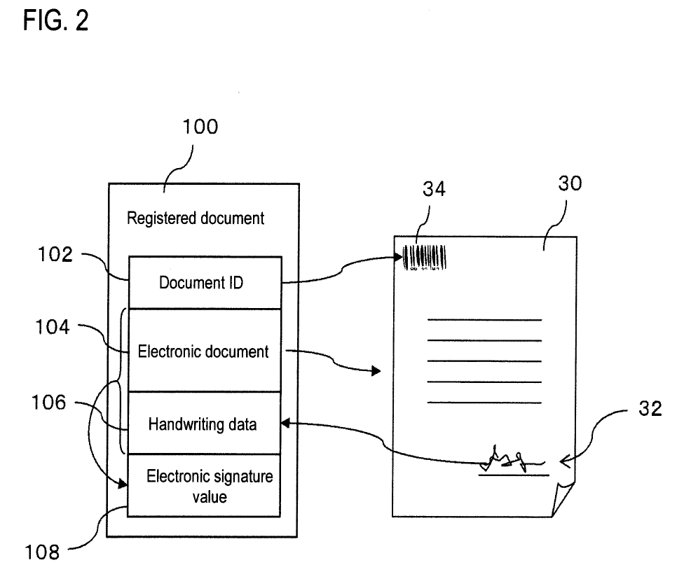

FIG. 2 schematically shows one example of a correspondence relation between the signed paper document 30 stored in the drawer 50 and the electronic document (registered electronic document 100) registered in the document management system 60. In this example, the registered document 100 includes a document ID 102, an electronic document 104, handwriting data 106 and an electronic signature value 108. The document ID 102 is unique identification information that the document management system 60 gives to the registered document 100. The electronic document 104 is data itself of an electronic document to be signed. The handwriting data 106 is data representing handwriting of the handwritten signature 32 that the user put on the paper document 30, which is obtained by printing out the electronic document 104. The electronic signature value 108 is signature information including a signature value of an electronic signature that is made with the signature key of the user on data obtained by combining the electronic document 104 and the handwriting data 106. Also, identification information 34 representing the document ID 102 of the registered document 100 corresponding to the paper document 30 is embedded on the paper document 30 by print (e.g., bar code print) or other methods. The document ID 102 and the identification information 34 have a role of associating the registered document 100 and the paper document 30 with each other.

If there is a request for verifying a signature of an electronic document which both the electronic method signature and handwritten signature are made on by the signature device 40 and which are stored in the document management system 60, a signature verification system 70 firstly verifies the electronic signature associated with the electronic document. Then, if the verification is successful (i.e., the signature verification system 70 determines that the electronic signature is authentic), the signature verification system 70 collates the handwritten signature on the paper document, which corresponds to the electronic document and is stored in the drawer 50, and the handwriting data stored in the document management system 60 associated with the electronic document so as to verify whether or not they represent the same handwritten signature. If this verification is successful (i.e., the signature verification system 70 determines that the handwritten signature and the handwriting data are identical), the signature verification system 70 determines that the electronic document is authentic one to which the user has put his/her signature.

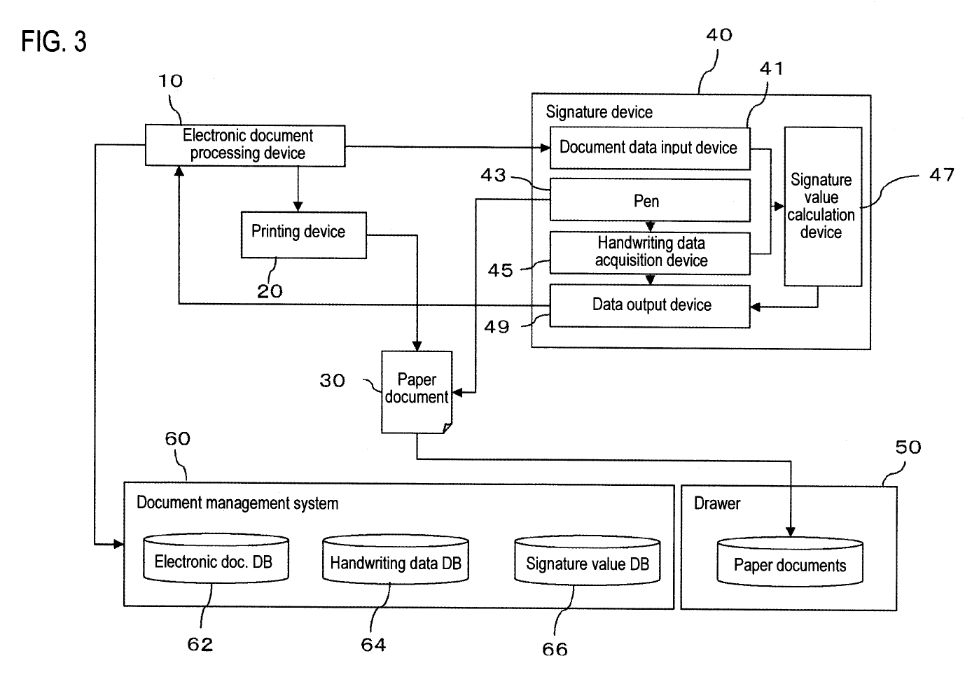

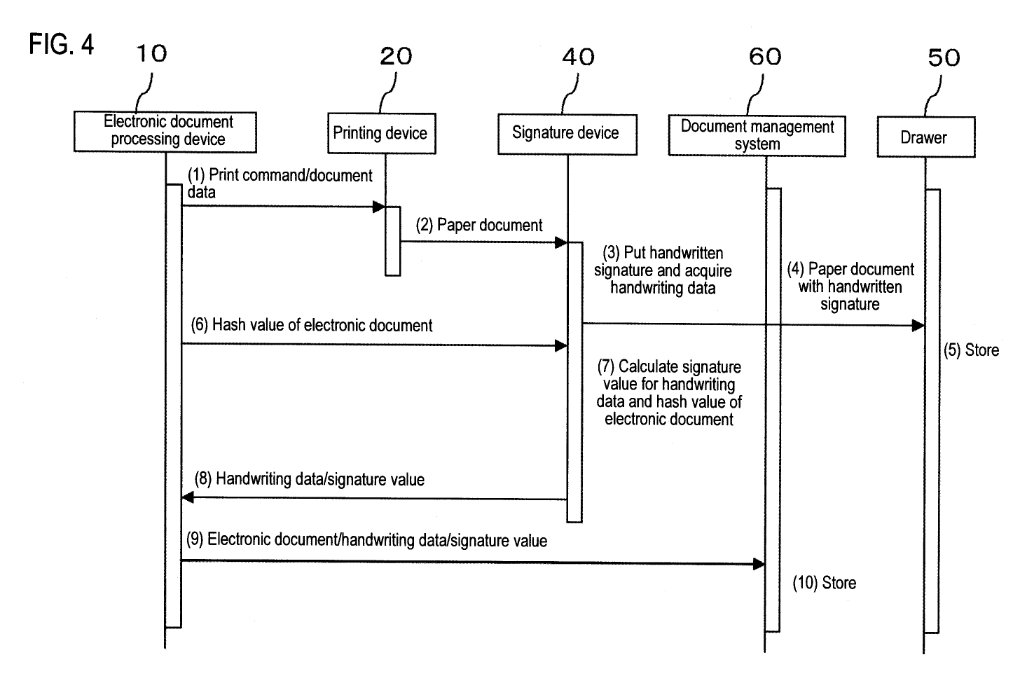

Referring now to FIGS. 3 and 4, the system for user's signature according to this exemplary embodiment will be described below in more detail. In FIGS. 3 and 4, the same elements are denoted by the same reference numerals as those of the system shown in FIG. 1.

The electronic document processing device 10 stores one or more electronic documents. The electronic document processing device 10 may have a function of displaying or editing the stored electronic document(s). Also, the electronic document processing device 10 may have a function of creating an electronic document. The electronic document processing device 10 requests a user to put his/her signature to the electronic document stored therein, and registers the resultant document in the document management system 60. The electronic document processing device 10 may be of any type as long as it requests the user to sign. For example, examples of the electronic document processing device 10 include an electronic medical chart system that requests a doctor to sign an electronic clinical chart in view of its contents, a draft circulation system that requests persons in charge to sign as a result of their approval, and a system for filing a tax return from a remote location.

Recently, a system for managing a signature key not in the electronic document processing device 10 but in a device independent from the electronic document processing device 10 such as an IC card has appeared. Such a system originates in a sense that signature keys for making signatures belong to individual users. In this exemplary embodiment, the signature key is managed within the pen-type signature device 40.

The signature device 40 is a pen-type device, and includes a processor, a memory and a program for performing information processing for electronic signature, and a camera, another hardware and a program for reading handwriting of a handwritten signature, in addition to a pen 43 that has a pen point for actually making the handwritten signature on the paper document 30. That is, the signature device 40 includes a document data input device 41 for receiving data regarding the electronic document to be signed from the electronic document processing device 10, a handwriting data acquisition device 45 for acquiring the handwriting data of the handwritten signature made by the pen 43, a signature value calculation device 47 for calculating a signature value for the handwriting data and information, that are input into the document data input device 41, using the user's signature key contained therein, and a data output device 49 for outputting the handwriting data and the signature value.

Several methods for acquiring the handwriting data in the handwriting data acquisition device 45 are feasible. For example, there is a method in which an acceleration sensor is contained in the signature device 40, motion of the signature device 40 is analyzed based on measurement results of this sensor, and information of the motion is obtained as the handwriting data. Also, there is another method in which a tablet device having a digitizer function is used as an underlay over which the handwriting is done, a position change of the pen point in the signature device 40 every moment is acquired from the tablet device, and the acquired positions of the pen point, which change over time, are used as the handwriting data.

Also, there is still another method using a so-called digital pen. In one example of this method, position information representing positions of respective points on a paper are printed on the paper as code patterns such as dot patterns with being superimposed on an image of the electronic document, or the image of the electronic document is printed on a paper on which such code patterns are printed in advance. Then, the handwriting data is obtained using the positional information (e.g., see JP 2007-41691 A (corresponding to US 2007/0023523 A)). In the method of this type, the position information located in a position of the pen point at each moment is detected during signature work by a camera built in the signature device 40, and handwriting data representing a series of positions of the pen point (two-dimensional positions on the paper) at the respective moments is obtained. In the method of this type, the code patterns may represent identification information for identifying the paper or a page as well as the positional information of the respective points. Therefore, if this identification information and the document ID 102 of the registered document 100 are set to be the same value or are associated with each other, it becomes unnecessary to print the identification information 34 in the form of a bar code at a specific position on the paper document 30.

Any printing device 20 may be used so long as it can print an image of the electronic document, and may be a general-purpose printer. However, if the method of embedding the positional information onto a paper is adopted as the method for acquiring the handwriting data, the printing device 20 is required to have a function of embedding the positional information onto a paper. However, if the electronic document processing device 10 generates image data in which the positional information are superimposed on the image of the electronic document, it is unnecessary for the printing device 20 to have such a function.

The identification information 34 put into the paper document 30 may be printed at the specific position on the paper document 30 as a mechanically readable code image such as a bar code, or a human readable character string. Also, contents of the identification information 34 may be provided in the code patterns for displaying the positional information printed on the paper, as described above. Also, in the case of using a paper in which a minute device that can hold data such as an RFID tag is attached or buried, a value of the identification information 34 may be written into the minute device within the paper.

The signature value calculation device 47 calculates a signature value for data in question, using the signature key of the user, in accordance with a well-known electronic signature algorithm that uses the public key cryptosystem, for example. Then, a process for associating the signature value with the data in question is performed (in accordance with the standards such as an XML signature, for example).

The document management system 60 is a system for storing and managing the electronic document (registered document 100) on which the electronic signature and handwritten signature of the user are made by the signature device 40. In the example shown in FIG. 3, the electronic document 104, the handwriting data 106 and the electronic signature value 108 of the registered document 100 are stored in an electronic document DB (database) 62, a handwriting data DB 64, and a signature value DB 66, respectively. It should be noted that FIG. 3 is just one example. The database(s) may be configured in any manner so long as the electronic document 104, the handwriting data 106 and the electronic signature value 108 are managed in association with each other. The electronic document 104, the handwriting data 106 and the electronic signature value 108, which are managed in association with each other in the document management system 60, are further associated with the paper document 30 stored in the drawer 50 outside the document management system 60 through the document ID 102 (identification information 34), for example.

Also, it is not necessary that the document management system 60 is implemented by one computer so long as the electronic document 104, the handwriting data 106 and the electronic signature value 108 are stored in association with the paper document 30 having a handwritten signature. Accordingly, the electronic document 104, the handwriting data 106 and the electronic signature value 108 may be stored in separate storage devices in association with the document ID 102.

The drawer 50 is a cabinet for physically storing paper documents 30 with handwritten signatures. The stored paper document 30 is physical proof that the user puts the electronic signature on the electronic document and/or the handwritten signature on the paper document. Instead of or in addition to storing the paper document 30 with handwritten signature itself, image data obtained by scanning the paper document 30 may be held. In this case, the image data may be stored in the database in association with a document ID 102 obtained by analyzing the identification information 34.

Referring to FIG. 4, an operation of this system in affixing a signature will be described below.

When a user puts his/her own signature on an electronic document, the user inputs designation of the electronic document to be signed to the electronic document processing device 10, and inputs a command to sign it. In response to this command, (1) the electronic document processing device 10 sends data representing an image of the electronic document to the printing device 20, and issues a print command. (2) The printing device 20 prints based on the sent data, and outputs a paper document 30 on which the electronic document is printed.

Next, (3) the user puts a handwritten signature on the printed paper document 30, using the pen 43 of the signature device 40. At this time, the signature device 40 acquires handwriting data 105 of the handwritten signature using the handwriting data acquisition device 45. (4) The paper document 30 with the handwritten signature is forwarded to the drawer 50, and (5) is stored in the drawer 50. The drawer 50 may be a document cabinet provided in an office where this system is installed, or a document cabinet for a company or a public institution for safely storing signed paper documents.

Next, (6) the signature device 40 (the document data input device 41) receives a hash value of the electronic document to be signed from the electronic document processing device 10. The signature device 40 may receive the electronic document itself instead of the hash value of the electronic document, and calculate the hash value in the signature device 40. However, for the purpose of reducing communication traffic, the hash value is acquired in this exemplary embodiment.

In the signature device 40, which has received the hash value of the electronic document, (7) the signature value calculation device 47 calculates a signature value for the handwriting data and the hash value. More specifically, for example, the signature value calculation device 47 combines the hash value of the electronic document and the handwriting data, calculates a hash value of the resultant data, and performs an encryption process for the hash value of the calculation result with the user's signature key that the signature device 40 has. Alternatively, the signature value calculation device 47 may combine the hash value of the electronic document and the hash value of the handwriting data, calculate a hash value for the combined data, and encrypts the calculation result with the signature key. Also, the signature value calculation device 47 may calculate a signature value by encrypting the hash value of data obtained by combining the electronic document itself and the handwriting data, with the signature key. (8) The signature device 40 returns the thus calculated signature value and the handwriting data to the electronic document processing device 10.

(9) The electronic document processing device 10, which has received the handwriting data and the signature value, sends these data together with the electronic document to be signed to the document management system 60. At this time, the electronic document processing device 10 may verify the signature value received from the signature device 40. If the electronic document processing device 10 verifies the signature value, it is possible to detect fraud such as that the signature device 40 intentionally calculate a signature value of another electronic document (the electronic document processing device 10 can prevent false charges of fraud by the signature device 40).

(10) The document management system 60 stores the sent electronic document, the sent handwriting data and the sent signature value in association with each other.

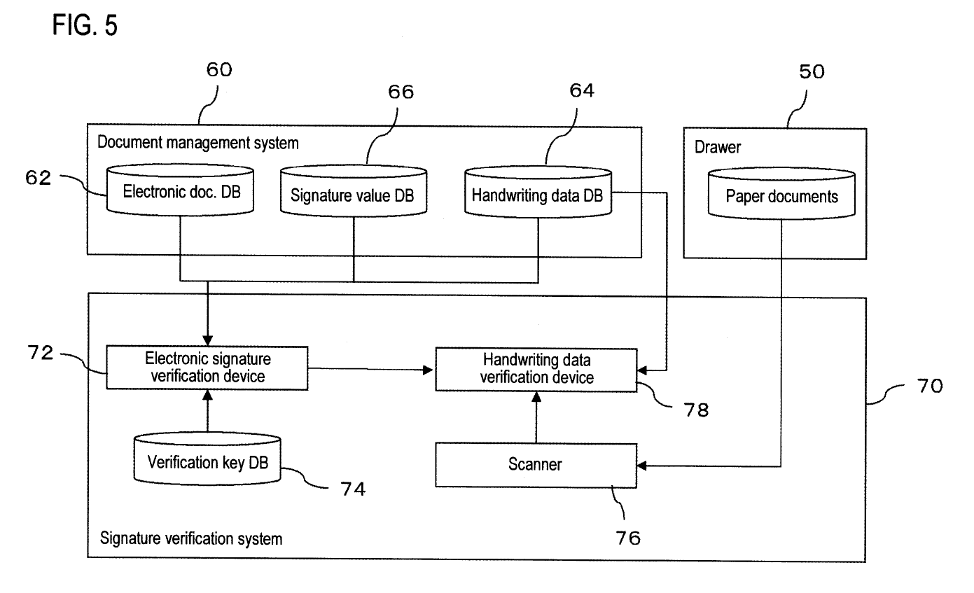

Referring now to FIG. 5, a system for verifying the signature of the signed electronic document (registered document 100), which is registered in the document management system 60 in the above manner, will be described below.

The signature verification system 70 includes an electronic signature verification device 72 for verifying an electronic signature and a handwriting data verification device 78 for verifying handwriting data. In a verification key DB 74, verification keys (e.g., public keys of respective users) for verifying electronic signatures of the respective users are registered. The verification key DB 74 may be provided in a computer in which a program of the signature verification system 70 is installed or in the electronic signature verification device 72. Alternatively, the verification key DB 74 may be configured as a repository that is connected via a network to the computer. A scanner 76 optically scans a paper surface of a paper document, and generates image data representing an image of the paper surface. The scanner 76 supplies the image data to the handwriting data verification device 78.

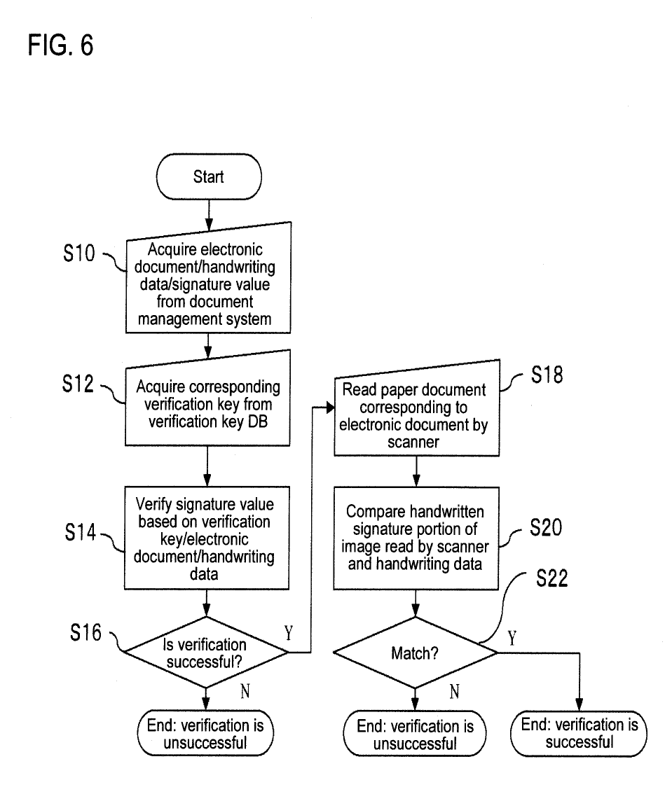

FIG. 6 shows one example of a signature verification process using this signature verification system 70. In this procedure, to verify the signature affixed to the registered document 100 stored in the document management system 60, a user inputs information designating the registered document 100 into the signature verification system 70, and instructs execution of signature verification. When this instruction is received, at first, the electronic signature verification device 72 in the signature verification system 70 receives the registered document 100 (i.e., data including the electronic document 104, the handwriting data 106 and the electronic signature value 108 and also including information (e.g., document ID 102) indicating association with the paper document 30 in the drawer 50) indicated by this designation information from the document management system 60 (S10). The user may acquire the registered document 100 from the document management system 60 in advance, and input it into the signature verification system 70. Next, the electronic signature verification device 72 searches the verification key DB 74 for a verification key using information (such as a key ID) specifying the verification key included in the electronic signature value 108, and acquires the verification key (S12). If the verification key, the electronic document, the handwriting data and the signature value are all acquired, the electronic signature verification device 72 verifies the signature (S14). Specifically, a hash value of the electronic document is calculated, and then a hash value of data obtained by combining the hash value of the electronic document and the handwriting data is further calculated. Then, it is determined as to whether or not this calculation result matches what is obtained by decoding the signature value with the verification key. If the calculation result matches the decoding result, the verification is successful; otherwise, the verification is unsuccessful. At this stage, the failure of verification (determination result at S16 is negative (N)) means that the electronic document, the handwriting data or the signature value has been falsified. In this case, since the registered document 100 itself is unreliable, the process is terminated.

If the verification of the electronic signature is successful (determination result at S16 is affirmative (Y)), the handwriting data verification device 78 verifies the handwriting data. At first, a paper document corresponding to the electronic document to be verified is retrieved from the drawer 50. For this search, the paper document 30 having the identification information 34 corresponding to the document ID 102 of the registered document 100 may be identified from among the paper documents 30 in the drawer 50. If such a paper document 30 is found, the paper document 30 is read by the scanner 76 (S18), and converted into image data. On the other hand, the handwriting data 106 (represented as time-series coordinates or vectors) in the registered document 100 is also converted into image data (e.g., bitmap image). Then, the image of the handwritten signature in the image data read by the scanner 76 and the image data of the handwritten signature represented by the handwriting data 106 are compared, and a degree of coincidence is calculated (S20). In calculating the degree of coincidence between the images, a known comparison technique between images may be used. In comparing the images, an inclination or a size of an image(s) may be modified in advance using a related art. At step S20, it is determined as to whether or not the degree of coincidence is greater than or equal to a predetermined threshold value (S22). If the degree of coincidence does not reach the threshold value, it is determined that the verification is unsuccessful. If the degree of coincidence is greater than or equal to the threshold value, it is determined that the verification is successful.

Also, the user (who instructs verification) may be asked to determine whether or not both the handwritten signature coincide with each other in the following manner. That is, the degree of handwriting coincidence may be displayed as a numerical value on a monitor of the signature verification system 70. Alternatively, portions in which both the handwritten signature images coincide with each other and portions in which both the handwritten signature images don't coincide may be displayed in distinguishable manner.

If the verification is unsuccessful in the handwriting data verification device 78, the signature verification system 70 notifies to the user (who instructs verification) that there is a possibility that an unauthorized operation has been performed for the registered document to be verified, for example, through a monitor.

For example, it is assumed that the electronic document processing device 10 intends to perform an unauthorized operation so as to have a signer put his/her signature to a document B instead of a document A which the signer is to sign. Specifically, it is assumed that the electronic document processing device 10 provides a hash value of the document B to the signature device 40, instead of a hash value of the document A.

In this case, the signature device 40 puts an electronic signature based on the provided hash value of the document B and the handwriting data of the handwritten signature affixed to the printed document A. Herein, if the electronic document processing device 10 replaces the electronic document, which is to be registered in the document management system 60 together with the result of the electronic signature (electronic signature value) with the document B, the verification of the electronic signature in the electronic signature verification device 72 will be successful.

However, since the paper document of the document B with the handwritten signature by the signer does not exist at that time, the verification by the handwriting data verification device 78 is unsuccessful. That is, the signer confirms contents of a paper on which the image of the document A is printed and then signs it. Therefore, the handwritten signature of the signer made at that time is correctly put on the paper document of the document A. Since the handwriting of the handwritten signature is different every time even with the same person, there is no other paper document having the handwritten signature of the same handwriting as the handwritten signature put to the paper document of the document A. Even if a certain range (threshold value for the degree of coincidence) is given in which two handwritings are determined to be coincide, the probability that there is another paper document having the same handwritten signature as the handwritten signature on the document A is extremely low. Therefore, if the electronic document processing device 10 performs an unauthorized operation for substituting the electronic document to be signed, the handwriting verification for the registered document 100 of the signature result is highly likely to be unsuccessful. Thus, such a document does not serve as a valid document.

Instead, the paper document of the document A to which the signer puts the handwritten signature at that time exists in the drawer 50. If the handwritten signature put on the paper document of the document A and the handwriting data associated with the document B are compared by the handwriting data verification device 78, it will be found that they don't match. Therefore, it can be found that the signer signed the document A, not the document B.

In the example of FIGS. 5 and 6, the handwriting verification is made using the paper document itself with the handwritten signature stored in the drawer 50. However, it is noted that this is not essential. Instead, the image data, which is the scan result of the paper document, may be stored, and the handwriting verification may be made by comparing the handwritten signature in the image data and the handwriting data 106 in the registered document 100. For example, to detect fraud by the electronic document processing device 10 as described above, the system for scanning the paper document and storing the image data of the scan result may be provided separately from the electronic document processing device 10.

In the above system, individual users possess the signature devices 40. The signature key stored in each signature device 40 and the various functions described above of each signature device 40 are considered to be reliable to the corresponding user. In this case, even if the electronic document processing device 10 or the document management system 60 performs fraud, data itself generated by the signature device 40 is reliable, and it is difficult to falsify the paper document 30 stored in the drawer 50. Therefore, the fraud results in failure of the electronic signature verification or failure of the handwritten-signature handwriting verification.

In the system according to the exemplary embodiment as above exemplified, the electronic document processing device 10, the document management system 60 and the signature verification system 70 are typically realized on separate computers. However, two or more of them may be of course realized on the same computer. Also, the internal functions (such as the electronic signature verification device 72 and the handwriting data verification device 78) of the signature verification system 70 may be realized on different computers that can communicate with each other.

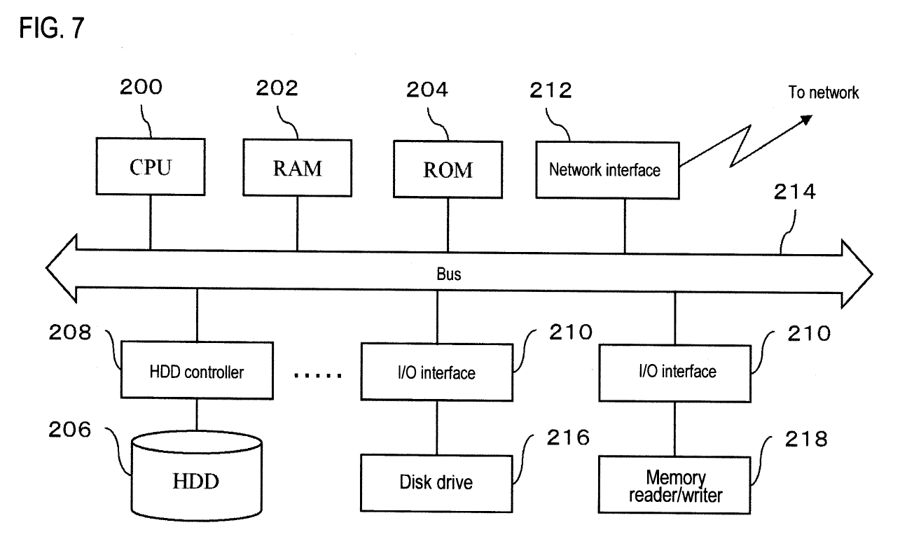

In the electronic document processing device 10, the document management system 60, the signature verification system 70 and the signature device 40, parts for performing the information processing are typically realized by having a general-purpose computer(s) execute a program(s) describing the above functions of the respective devices. The computer has a circuit configuration of hardware in which a microprocessor such as a CPU, a memory (primary storage) such as a random access memory (RAM) 202 and a read-only temporary memory (ROM) 204, an HDD controller 208 for controlling an HDD (Hard Disk Drive) 206, various kinds of I/O (input/output) interface 210, and a network interface 212 for controlling the connection with a network such as a local area network are connected via a bus 214, for example, as shown in FIG. 7. Also, a disk drive 216 for reading from and writing into a portable disk recording medium such as a CD or DVD, and a memory reader/writer 218 for reading from and writing into a portable non-volatile recording medium compliant with various standards such as a flash memory, for example, may be connected via the I/O interface 210 to the bus 214. A program describing the processing contents of each functional module as described above is stored in a recording medium such as a CD or DVD, or distributed via communication means such as a network and stored in a fixed storage such as a hard disk drive, and installed in the computer. The program stored in the fixed storage is read into the RAM 202 and executed by the microprocessor such as the CPU 200 to implement a group of functional modules as exemplified above. Part or all of the group of functional modules may be configured by a hardware circuit such as a dedicated LSI (Large Scale Integration), ASIC (Application Specific Integrated Circuit), or FPGA (Field Programmable Gate Array).

What is claimed is:

1. A signature system comprising:
a print unit that prints an electronic document to generate a paper document corresponding to the electronic document;
an acquisition unit that acquires handwriting information of a handwritten signature that is put to the paper document by a signer;
a signature value calculation unit that calculates an electronic signature value for (i) information which is generated from the electronic document and the handwriting information or (ii) information which is generated from a feature amount of the electronic document and the handwriting information, using a signature key of the signer;
an association unit that associates (i) the electronic signature value, (ii) the electronic document, (iii) the handwriting information, and (iv) the paper document to which the handwritten signature is put by the signer or an image obtained by reading the paper document to which the handwritten signature is put by the signer;
an electronic signature verification unit that verifies whether or not the electronic signature value associated with the electronic document is valid, using the electronic document, the handwriting information associated with the electronic document and a verification key of the signer; and
a handwritten signature verification unit that verifies the handwriting information associated with the electronic document by comparing the handwriting information associated with the electronic document and the image, which is obtained by reading the paper document to which the handwritten signature is put by the signer and is associated with the electronic document.

2. The signature system according to claim 1, further comprising:
a notification unit, wherein if the electronic signature verification unit determines that the electronic signature value associated with the electronic document is valid and if the handwritten signature verification unit determines that the handwriting information associated with the electronic document is invalid, the notification unit notifies information indicating that there is a possibility that an unauthorized operation has been performed for the electronic document.

3. A signature device comprising:
an acquisition unit that acquires handwriting information of a handwritten signature which is put by a signer to a paper document that is a result of printing out an electronic document;
a signature value calculation unit that calculates an electronic signature value for (i) information generated from the electronic document and the handwriting information or (ii) information generated from a feature amount of the electronic document and the handwriting information, using a signature key of the signer; and
an output unit that outputs the electronic signature value and the handwriting information so that the electronic document and the paper document to which the handwritten signature is put by the signer or an image obtained by reading the paper document to which the handwritten signature is put by the signer are associated with each other.

4. A signature verification device comprising:
an acquisition unit that acquires an electronic document and handwriting information indicating handwriting of a handwritten signature which is put by a signer to a paper document corresponding to the electronic document, or an electronic signature value for a feature amount of the electronic document and the handwriting information;
an electronic signature verification unit that verifies whether or not the electronic signature value associated with the electronic document is valid, using the electronic document, the handwriting information associated with the electronic document and a verification key of the signer; and
a handwritten signature verification unit that verifies the handwriting information by comparing an image obtained by reading the paper document, which is associated with the electronic document and which the handwritten signature is put to by the signer, and the handwriting information.

5. A computer-readable medium storing a program that causes a computer to execute a signature verification process, the signature verification process comprising:
acquiring an electronic document and handwriting information indicating handwriting of a handwritten signature which is put by a signer to a paper document corresponding to the electronic document, or an electronic signature value for a feature amount of the electronic document and the handwriting information;
verifying whether or not the electronic signature value associated with the electronic document is valid, using the electronic document, the handwriting information associated with the electronic document and a verification key of the signer; and
verifying the handwriting information by comparing an image obtained by reading the paper document, which is associated with the electronic document and which the handwritten signature is put to by the signer, and the handwriting information.

6. A signature verification method comprising:
acquiring an electronic document and handwriting information indicating handwriting of a handwritten signature which is put by a signer to a paper document corresponding to the electronic document, or an electronic signature value for a feature amount of the electronic document and the handwriting information;
verifying whether or not the electronic signature value associated with the electronic document is valid, using the electronic document, the handwriting information associated with the electronic document and a verification key of the signer; and
verifying the handwriting information by comparing an image obtained by reading the paper document, which is associated with the electronic document and which the handwritten signature is put to by the signer, and the handwriting information.
